(19) United States
(12) Patent Application Publication
(10) Pub. No.: US 2010/0290923 A1
(43) Pub. Date: Nov. 18, 2010

(54) FAN ASSEMBLY

(75) Inventor: LEI LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/479,868

(22) Filed: Jun. 8, 2009

(30) Foreign Application Priority Data
May 12, 2009 (CN) 200910302246.3

(51) Int. Cl. F04D 27/00; G01P 3/36; F04D 19/00

(52) U.S. Cl. 417/63; 324/175; 417/423.1

(57) ABSTRACT

A fan assembly includes a sensor, a display device, and a fan. The sensor is coupled to the fan, to sense a rotary speed of the fan in real time, and to output a speed signal. The display device is coupled to the sensor, and to calculate the rotary speed of the fan according to the speed signal, and convert the rotary speed to a digital signal to be shown.

### BACKGROUND

1. Technical Field

The present disclosure relates to a fan assembly.

2. Description of Related Art

Electronic devices, such as central processing units (CPUs) and printed circuit boards (PCBs), frequently generate large amounts of heat during normal operation. Oftentimes, a fan is used to dissipate heat from an electronic device. Usually, a rotary speed of the fan is changeable with temperature of the electronic device. Sometimes, the rotary speed of the fan needs to be acquired in real time, for analyzing noise of the fan, to aid in the design of a better fan. However, acquiring the changeable rotary speed of the fan in real time is often difficult.

### BRIEF DESCRIPTION OF THE DRAWINGS

FIG. 1 is an exploded, isometric view of an exemplary embodiment of a fan assembly, the fan assembly including a display device and a sensor.

FIG. 2 is an assembled, isometric view of the fan assembly of FIG. 1.

FIG. 3 is a block diagram of the display device and the sensor of FIG. 1 according to an exemplary embodiment.

### DETAILED DESCRIPTION

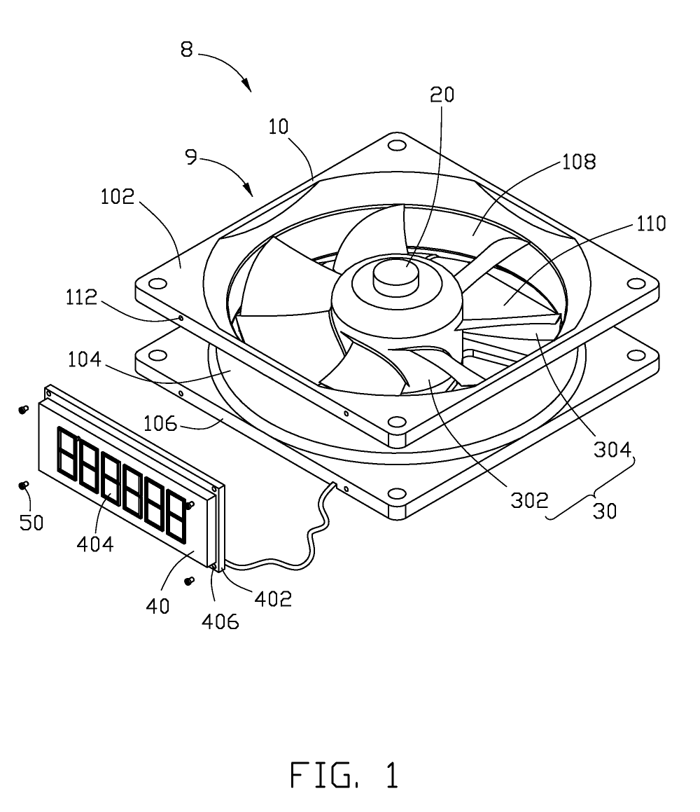

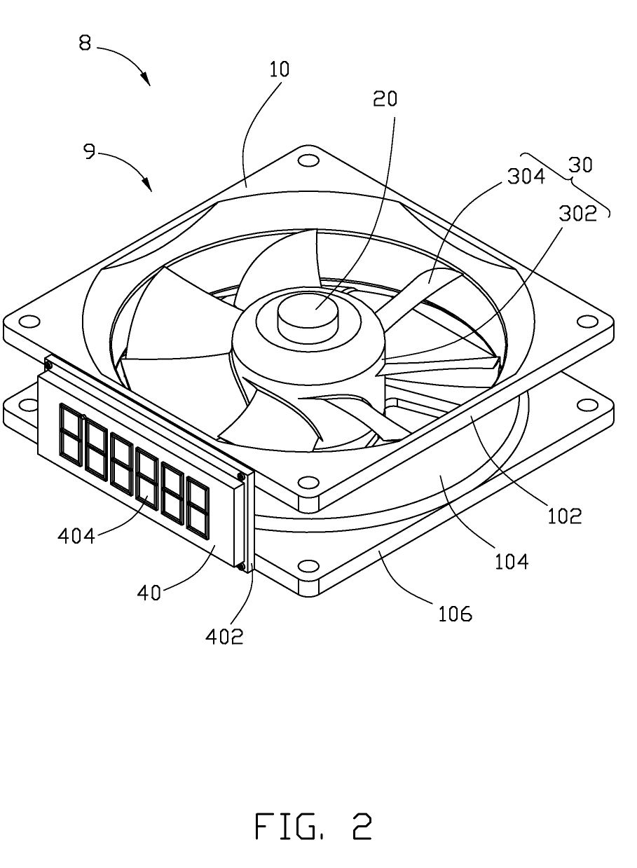

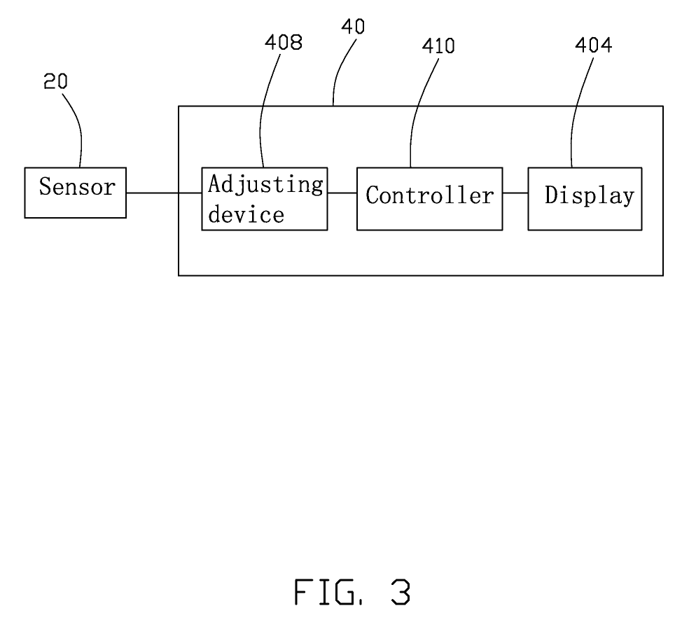

Referring to FIGS. 1 to 3, an exemplary embodiment of a fan assembly 8 includes a sensor 20, a display device 40, and a fan 9. The fan 9 includes a frame 10, and a motor (not visible) with an impeller 30 arranged in the frame 10.

The frame 10 includes an upper frame 102, a lower frame 106 parallel to the upper frame 102, and a circular side frame 104 vertically located between the upper frame 102 and the lower frame 106. A lateral wall of each of the upper frame 102 and the lower frame 106 defines a plurality of installing holes 112, to secure the display device 40 to the fan 9. The upper frame 102 defines a through hole 108, and a lower surface of the lower frame 106 defines a through hole 110. The two through holes 108 and 110 are aligned and communicated with each other via the side frame 104. A receiving space is defined by inner walls bounding the through holes 108, 110, and the side frame 104. The impeller 30 includes a circular hub 302 rotatably mounted to the motor, and a plurality of vanes 304 radially extending from a circumference of the hub 302. When the impeller 30 rotates, air is drawn into the receiving space by the plurality of vanes 304 through one of the through holes 108, 110, and expelled through the other one of the through holes 108, 110.

The sensor 20 is located on the hub 302, and is electrically coupled to the display device 40, to sense a rotary speed of the fan 9 in real time, thereby to provide a speed signal to the display device 40. In one embodiment, the sensor 20 can be an infrared photoelectric sensor or a magnetic sensor. For each rotation of the fan 9, a high level (e.g. 5V) or a low level (e.g. 0V) signal can be triggered in the sensor 20.

The display device 40 includes a rectangular main body 402, a display 404, an adjusting device 408, and a controller 410 disposed in the main body 402. The main body 402 defines a plurality of mounting holes 406 for fastening the display device 40 to the frame 10 of the fan 9 via a plurality of fasteners 50. The display 404 is located on the main body 402 to show the rotary speed of the fan 9 in real time. The sensor 20 is electrically coupled to the controller 410 via the adjusting device 408, and the controller 410 is also electrically coupled to the display 404. The adjusting device 408 is to receive the speed signal output from the sensor 20, adjust the speed signal to eliminate attenuation or interference of the speed signal, and then send an adjusted speed signal to the controller 410. In one embodiment, the adjusting device 408 can be an amplifier to amplify the speed signal. The controller 410 is to calculate the rotary speed of the fan 9 according to the adjusted speed signal, and convert the rotary speed to a digital signal to be displayed on the display 404.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A fan assembly, comprising:
a fan;
a sensor coupled to the fan to sense a rotary speed of the fan in real time, and output a speed signal; and
a display device coupled to the sensor to calculate the rotary speed of the fan according to the speed signal, and convert the rotary speed to a digital signal to be shown.

2. The fan assembly of claim 1, wherein the display device comprising:
an adjusting device coupled to the sensor to receive the speed signal, adjust the speed signal, and output an adjusted speed signal;
a controller coupled to the adjusting device to calculate the rotary speed of the fan according to the adjusted speed signal, and convert the rotary speed to the digital signal; and
a display coupled to the controller to display the digital signal.

3. The fan assembly of claim 2, wherein the adjusting device is an amplifier to amplify the speed signal.

4. The fan assembly of claim 1, wherein the sensor is an infrared photoelectric sensor, and for each rotation of the fan, a high level signal is triggered in the sensor.

5. The fan assembly of claim 4, wherein the high level signal is 5 volts.

6. The fan assembly of claim 1, wherein the fan comprises a frame defining a plurality of installing holes for securing the display device.

7. The fan assembly of claim 6, wherein the display device defines a plurality of mounting holes for fastening the display device to the frame of the fan via a plurality of fasteners.

8. The fan assembly of claim 6, wherein the fan further comprising an upper frame, a lower frame, and a circular frame vertically located between the upper frame and the lower frame, lateral walls of the upper frame and the lower frame define the plurality of installing holes.

9. The fan assembly of claim 8, wherein the upper frame defines a first through hole, and the lower frame defines a second through hole, wherein air is drawn into the frame through one of the first and second through holes and is expelled through the other one of the first and second through holes, in response to the fan in operation.
